(19) United States
(12) Patent Application Publication
(10) Pub. No.: US 2023/0138626 A1
(43) Pub. Date: May 4, 2023

(54) ELECTROMECHANICAL INSTALLATION FOR AN AIRCRAFT WITH A TURBOGENERATOR, METHOD FOR EMERGENCY SHUTDOWN OF AN AIRCRAFT TURBOGENERATOR AND CORRESPONDING COMPUTER PROGRAM

(71) Applicant: SAFRAN HELICOPTER ENGINES, Bordes (FR)

(72) Inventors: Romain Jean Gilbert THIRIET, Moissy-Cramayel (FR); David Bernard Martin LEMAY, Moissy-Cramayel (FR)

(21) Appl. No.: 18/000,885

(22) PCT Filed: Jun. 14, 2021
(86) PCT No.: PCT/FR2021/051055

§ 371 Date: Dec. 6, 2022

(30) Foreign Application Priority Data
Jun. 17, 2020 (FR) 2006328

(51) Int. Cl. B64D 41/00; H02H 7/06

(52) U.S. Cl. CPC B64D 41/00; H02H 7/06; B64D 2221/00

(57) ABSTRACT

An aircraft with an electrical network including electrical subnetworks; a turbo generator including a gas turbine, an electricity generator with permanent magnets having phase groups respectively connected to the electrical subnetworks, and, for each phase group, an isolation device; and a control device designed to detect a short circuit in at least one of the phase groups, each phase group in which a short circuit is detected being described as defective and each other phase group being described as healthy and, in response to the detection of the short circuit, to disconnect this defective phase group from its associated electrical subnetwork and to command the shutdown of the gas turbine. The control device is also designed, in response to the detection of the short circuit, to keep each healthy phase group connected to its electrical subnetwork.

The present invention relates to an electromechanical installation for an aircraft with a turbogenerator, a method for emergency shutdown of an aircraft turbogenerator and a corresponding computer program.

It is known from the prior art an electromechanical installation for an aircraft, of the type comprising:

an electrical network comprising electrical sub-networks electrically disconnected from each other and each comprising at least one electrical equipment;

a turbogenerator comprising:

a gas turbine,

a permanent magnet electrical generator designed to be mechanically driven by the gas turbine and having phase groups respectively connected to the electrical sub-networks, and

for each phase group, an isolation device designed to disconnect the phase group from its associated electrical sub-network;

a control device adapted to detect a short-circuit in at least one of the phase groups, each phase group in which a short-circuit is detected being referred to as defective and each other phase group being referred to as healthy, and, in response to the detection of the short-circuit, on the one hand, to control the isolation device associated with each defective phase group to disconnect that defective phase group from its associated electrical sub-network and, on the other hand, to control a shutdown of the gas turbine.

Specifically, in the prior art, the control device is designed to trigger a shutdown procedure consisting in controlling all the isolation devices to disconnect all the defective and healthy phase groups from the electrical sub-networks. The purpose of this disconnection is to prevent the failure from spreading downstream to the electrical network.

A problem with the aircraft propulsion system according to the prior art is that when a short-circuit is detected in the electrical generator, the shutdown procedure is triggered but the deceleration time of the gas turbine is long, for example in the order of several tens of seconds. During this time, the electrical generator is driven in rotation by the gas turbine and therefore continues to supply power. There is then a very high risk of local heating which could cause a fire departure in the electrical generator. In particular, an electrical and/or thermal insulator is usually provided in the electrical generator and the local heating can cause it to catch fire. Also, when the electrical generator is oil-cooled, the latter can ignite.

In the present invention, an attempt has been made to solve this problem of the risk of overheating which could cause a fire departure in the electrical generator, by providing an aircraft propulsion system which allows to avoid at least one portion of the aforementioned problems and constraints.

It is therefore an object of the invention to provide an aircraft propulsion system of the aforementioned type, characterised in that the control device is further designed, in response to the detection of the short-circuit, to keep each healthy phase group connected to its electrical sub-network.

Indeed, the inventors have found that the main problem with completely disconnecting the electrical network from the electrical generator in response to the detection of a short-circuit is that the electrical generator no longer has a charge and therefore no longer provides braking torque to decelerate the gas turbine. With the invention, the healthy phase group or groups remain connected to their respective sub-networks, thus allowing to keep a charge for the electrical generator and thus braking the gas turbine.

Optionally, the control device is advantageously designed, after keeping each healthy phase group connected to its electrical sub-network for some time, to disconnect all the phase groups from the electrical sub-networks by controlling the isolation device associated with each healthy phase group to disconnect that healthy phase group from its associated electrical sub-network.

Optionally also, the control device is further designed to receive a measurement of a rotational speed of the electrical generator, to detect whether a predefined condition relating to the received rotational speed is achieved, this predefined condition being for example that the rotational speed falls below a predefined threshold, and, in response to the detection of the achievement of the predefined condition, to carry out the step of disconnecting all phase groups of the electrical sub-networks.

Optionally also, the control device is designed, in response to the detection of the short-circuit, to increase an electrical power consumption of at least one equipment of an electrical sub-network connected to one of the healthy phase group or groups.

Optionally also, one of the electrical sub-networks comprises a battery, and, to increase the electrical power consumption of the battery, the control device is designed to increase an electrical voltage applied to the battery by its electrical sub-network so that the battery recharges.

Also optionally, to increase the electrical power consumption of a battery, the control device is designed to increase an electric voltage applied to the battery by its electrical sub-network so that the battery recharges and/or, to increase the electrical power consumption of an electric motor, the control device is designed to control the electric motor in order to increase a rotational speed of the electric motor and/or to control the electric motor so that the electric motor generates a reactive current.

Optionally also, the installation further comprises a device for connecting the electrical sub-networks and the control device is designed, in response to the detection of the short-circuit, to control the connection device to connect the electrical sub-network associated with each defective phase group to the electrical sub-network associated with one of the healthy phase group or groups.

Optionally also, the installation further comprises an electrical charging device and a connection system designed to selectively connect the electrical charging device to one or more of the electrical sub-networks and the control device is designed, in response to the detection of the short-circuit, to connect the electrical charging device to an electrical sub-network associated with a healthy phase group.

The invention also relates to an aircraft comprising an installation according to the invention.

The invention also relates to a method for emergency shutdown of a turbogenerator comprising a gas turbine and a permanent magnet electrical generator designed to be mechanically driven by the gas turbine, the method comprising:

a detection of a short-circuit in each of at least one of the phase groups of the electrical generator, the phase groups being respectively connected to electrical sub-networks of an electrical network, the electrical sub-networks being electrically disconnected from each other and each comprising at least one electrical equipment, each phase group in which a short-circuit is detected being referred to as defective and each other phase group being referred to as healthy; and

in response to the detection of the short-circuit:

a disconnection of each defective phase group from its associated electrical sub-network, and

a shutdown of the gas turbine;

characterised in that it further comprises, in response to the detection of the short-circuit, keeping of each healthy phase group connected to its electrical sub-network.

Also proposed is a computer program downloadable from a communication network and/or stored on a computer-readable medium, characterised in that it comprises instructions for executing the steps of a method, according to the invention, of emergency shutdown of a turbogenerator, when said program is executed on a computer.

The invention will be better understood with the aid of the following description, given only by way of example and made with reference to the attached drawings in which:

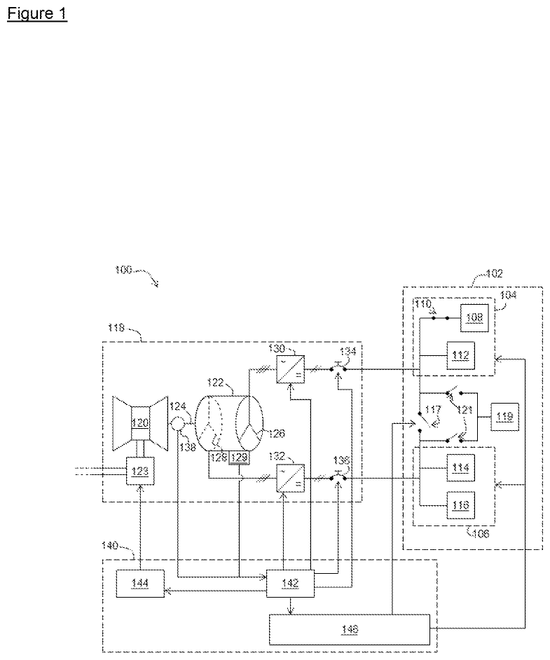

FIG. 1 is a simplified view of an electromechanical installation for an aircraft with a turbogenerator, according to one embodiment of the invention,

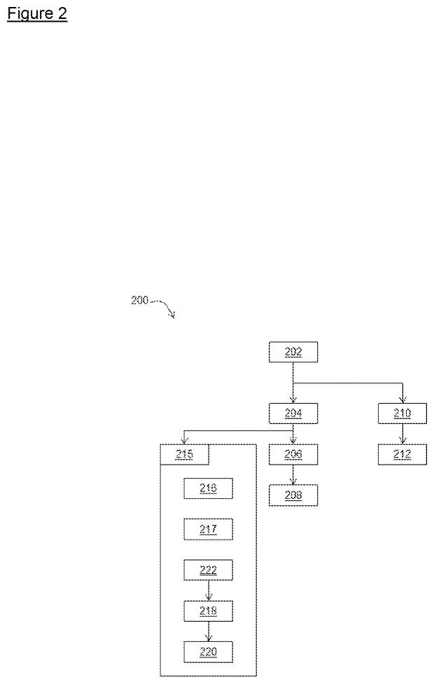

FIG. 2 is a block diagram illustrating the steps of an emergency shutdown method of the turbogenerator of FIG. 1, according to one embodiment of the invention,

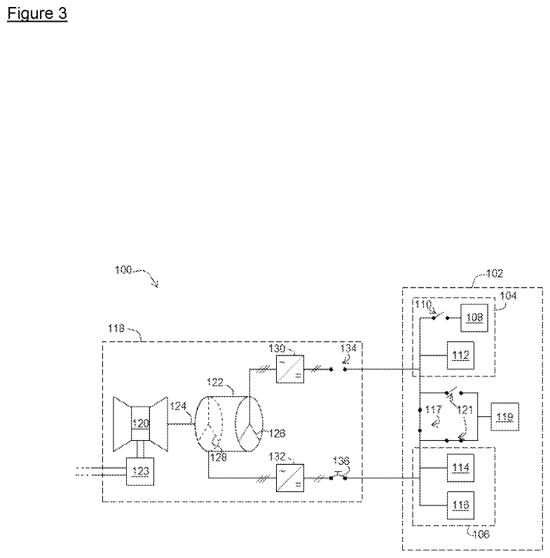

FIG. 3 is a view similar to FIG. 1, showing a first configuration of the installation during operation, and

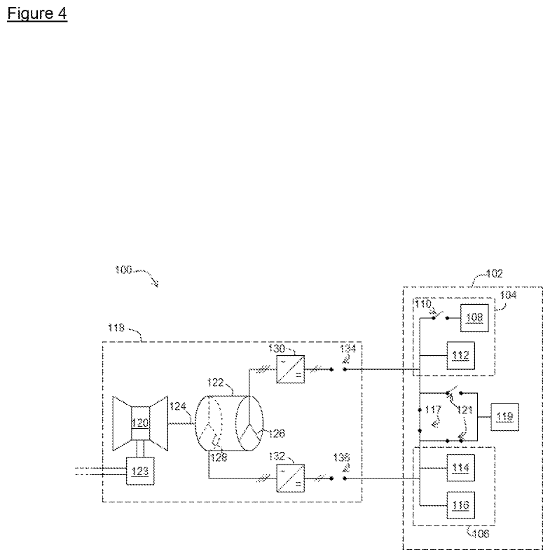

FIG. 4 is a similar view to FIG. 1, showing a second configuration of the installation during operation.

With reference to FIG. 1, an electromechanical installation 100 for an aircraft, according to one embodiment of the invention, will now be described.

The installation 100 firstly comprises an electrical network 102 comprising electrical sub-networks, two in the example described, designated by the references 104, 106. The electrical sub-networks 104, 106 are electrically disconnected from each other and each comprise at least one electrical equipment. In the example described, the first electrical sub-network 104 comprises a battery 108, an isolation device 110 for the battery 108 and another electrical equipment 112, while the second electrical sub-network 106 comprises an electric motor 114 and other electrical equipment 116. The electric motor 114 is used, for example, to drive a propeller (not shown) of the aircraft.

To allow the electrical sub-networks 104, 106 to be connected together, the installation 100 further comprises a device 117 for connecting the sub-networks.

Optionally, the electrical network 102 may further comprise an electrical charging device 119 consisting of, for example, one or more charging resistors, as well as a connection system 121 designed to selectively connect the electrical charging device 119 to one or more of the electrical sub-networks 104, 106. The connection system 121 comprises, for example, switches connecting the electrical charging device 119 respectively to at least some of the electrical sub-networks. In the example described, the connection system 121 is designed to connect the electrical charging device 119 selectively to all sub-networks 104, 106, and for this purpose comprises two respective switches.

The installation 100 further comprises a turbogenerator 118 forming a propulsion system for the aircraft.

The turbogenerator 118 firstly comprises a gas turbine 120 and a valve 123 for supplying fuel to the gas turbine 120.

The turbogenerator 118 further comprises a permanent magnet electrical generator 122 designed to be mechanically driven by the gas turbine 120 via a rotating shaft 124. The electrical generator 122 may be associated with a cooling system (not shown), for example forced air for the low power (typically less than 100 kW) and oil for higher power. The electrical generator 122 has phase groups respectively connected to the electrical sub-networks. Thus, in the written example, the electrical generator 122 comprises two phase groups 126, 128 respectively connected to the electrical sub-networks 104, 106. Each phase group 126, 128 is carried by a stator of the electrical generator 122. The phases of each phase group 126, 128 are for example arranged in star or triangle. Each phase usually comprises a winding, also referred to as reel, designed to have a phase current flowing through it and to have a phase voltage.

The turbogenerator 118 further comprises a system 129 for measuring operating parameters of the electrical generator 122, such as phase currents, phase voltages, phase temperatures and/or an oil temperature, in case the electrical generator 122 is oil-cooled.

In the example described, the electrical sub-networks 104, 106 use a direct voltage, referred to as HVDC (High Voltage Direct Current), while the phase groups 126, 128 each provide alternating phase voltages. Thus, the turbogenerator 118 comprises, for each phase group 126, 128, an alternating-direct voltage converter 130, 132 designed to convert the phase voltages of that phase group 126, 128 to the HVDC voltage of the associated electrical sub-network 104, 106.

The turbogenerator 118 further comprises, for each phase group 126, 128, an isolation device 134, 136 designed to disconnect the phase group 126, 128 from its associated electrical sub-network 104, 106, and thereby isolate that electrical sub-network 104, 106. For example, each isolation device 134, 136 comprises an electromechanical contactor, a pyrofuse or a Solid State Power Controller (SSPC).

In addition, the turbogenerator 118 comprises a speed sensor 138 designed to measure a rotational speed of the electrical generator 122. The speed sensor 128 is for example mounted on the rotation shaft 124.

The installation 100 further comprises a control device 140.

In the example described, the control device 140 firstly comprises a unit 142 for controlling in particular the voltage converters 130, 132, generally referred to as the Generator Control Unit (GCU).

The control device 140 further comprises a unit 144 for controlling in particular the gas turbine 120, generally referred to as the Electronic Engine Control Unit (EECU) or Full Authority Digital Engine Control (FADEC).

The control device 140 further comprises a unit 146 for controlling in particular the electrical network 102, referred to as Supervisor of the propulsion system.

In the example described, each of the modules 142, 144, 146 of the control device 140 comprises a computer system comprising a processing unit (such as a microprocessor) and a memory (such as a main memory) into which a computer program is intended to be charged, the computer program containing computer program instructions designed to be executed by the processing unit. Thus, the functions implemented by the control device 140 that will be described later, with reference to the method of FIG. 2, are implemented in the example described in the computer program, in the form of software bricks. In other embodiments, several of the modules 142, 144, 146 could be combined into a single computer system.

Alternatively, all or part of these software bricks could be implemented as hardware bricks, i.e., in the form of an electronic circuit, for example micro-wired, not involving a computer program.

With reference to FIG. 2, a method 200 according to one embodiment of the invention, for emergency shutdown of the turbogenerator 118 will now be described.

In a step 202, the GCU 142 detects a short-circuit in at least one of the phase groups 126, 128. In the following, each phase group 126, 128 in which a short-circuit is detected will be referred to as defective and each other phase group will be referred to as healthy. In other words, each phase group 126, 128 has the status “healthy” as long as the GCU 142 has not detected a short-circuit in that phase group 126, 128.

A short-circuit in a phase group 126, 128 is most often caused by an insulation defect in one or more windings. This short-circuit results in a significant increase in the electric current circulating in the phases, leading to very high local heating of the phases of the stator, which may lead to the initiation of a fire, for example in the electrical and/or thermal insulator, and/or to the ignition of the oil in the case of an oil-cooled electrical generator 122. Furthermore, as the risk of short-circuit is generally constant per phase group, the more phase groups there are, the greater the overall risk.

In a practical embodiment, the GCU 142 detects a short-circuit from measurements of the phase currents, phase voltages and/or phase temperatures. The GCU 142 can also take into account the measurement of the temperature of the oil in order to avoid false short-circuit detections (when the oil temperature measurement does not reveal an abnormal heating of the oil).

In response to the detection of the short-circuit, the following steps are implemented.

In a step 204, the GCU 142 controls the isolation device associated with each defective phase group to disconnect that defective phase group from its associated electrical sub-network. This electrical sub-network thus becomes isolated from the defective phase group. In addition, the GCU 142 keeps each healthy phase group connected to its electrical sub-network, leaving every other isolation device open (closed state).

For example, if in the installation illustrated in FIG. 1, the GCU 142 detects a short-circuit in the phase group 126, the following situation is obtained as illustrated in FIG. 3: the isolation device 134 is activated in the open state (isolating state) to isolate the electrical sub-network 104 from the defective phase group 126 while the isolation device 136 is left in the closed state to keep the healthy phase group 128 connected to its electrical sub-network 106.

Returning to FIG. 2, in a step 206, the GCU 142 monitors the measurement of the rotational speed of the electrical generator 122 provided by the sensor 138, to detect when the rotational speed is low enough to completely disconnect the electrical generator 122 from the electrical network 102. For this purpose, the GCU 142 detects, for example, whether a predefined condition relating to the received rotational speed is achieved. This predefined condition is, for example, that the rotational speed falls below a predefined threshold or becomes zero.

In a step 208, after keeping each healthy phase group connected to its associated electrical sub-network for a period of time, the GCU 142 disconnects all the phase groups 126, 128 from the electrical sub-networks 104, 106 by controlling the isolation device associated with each healthy phase group to disconnect that healthy phase group from its associated electrical sub-network.

For example, considering the situation in FIG. 3 in which the defective phase group 126 had been isolated from the electrical sub-network 104 in step 204, the GCU 142 disconnects the healthy phase group 128 in step 208 by controlling the isolation device 136 to the open state (isolating state), as illustrated in FIG. 4.

Thus, in the example described, the time during which each healthy phase group is kept connected to its electrical sub-network corresponds to the time that the rotational speed of the electrical generator 122 takes to reach the predefined condition. Alternatively, the step 206 could be omitted and the keeping time could be a fixed, predefined time.

Returning to FIG. 2, in parallel to the steps 204 to 208, in a step 210, the GCU 142 sends an emergency shutdown request to the FADEC 144.

In a step 212, in response to the emergency shutdown request, the FADEC 144 controls a shutdown of the gas turbine 120. To this end, in the example described, the FADEC 144 controls the closure of the fuel supply valve 123.

In the example described, following the step 204 of isolating one or more of the electrical sub-networks 104, 106, the electrical network 102 is modified, in a step 215, to increase the electrical power it collects from the electrical generator 122.

The step 215 comprises, for example, one or more of the steps 216, 217, 218 that will now be described.

In the step 216, the Supervisor 146 (e.g., in response to an emergency shutdown request from the GCU) and/or the GCU 142 causes the electrical charging of at least one equipment on an electrical sub-network associated with a healthy phase group to be increased, in order to increase the electrical power collected from the electrical network 102 to the electrical generator 122. Thus, if the healthy phase group or groups are not fully charged prior to the emergency shutdown procedure, the step 216 has the effect of further charging them to further brake the electrical generator 122.

For example, to increase the electrical charging of the battery 108, the GCU 142 increases the HVDC voltage of the electrical sub-network 104 to which the battery 108 belongs, so that the HVDC voltage becomes sufficiently higher than that of the battery 108 to impose a significant recharge current on it. This voltage increase is achieved, for example, by appropriately controlling the voltage converter 130 of the electrical sub-network 104 to which the battery 108 belongs. The voltage increase 130 is preferably calculated by the GCU 142 so that the recharge current remains within the operating limits of the battery 108, in particular below a maximum permissible recharge current, and to respect a maximum charge level of the battery 108.

Again, for example, to increase the electrical charging of the electric motor 114, the supervisor 146 controls the electric motor 114 to increase its rotational speed. Alternatively, the Supervisor 146 controls the electric motor to generate a reactive current. Indeed, this reactive current heats up the electric motor 114 without changing its rotational speed. The additional electrical power consumed by the electric motor 114 is thus dissipated as heat in the electric motor 114. It will be appreciated that, in another embodiment, the generation of the reactive current could be carried out in addition to the increase in the rotational speed.

In step 217, the electrical charging device 119 is used, for example, in the case where the one or more healthy phase groups are already fully charged, in particular if, for example, the battery 108 is already fully charged and it is not desired to change the charging of the electric motor 114 so as not to change the aerodynamics of the flight. The connection system 119 is thus controlled by the control device 140 to connect the electrical charging device 119 to at least one electrical sub-network associated with a healthy phase group in order to increase the electrical power collected by this electrical sub-network.

In the example shown in FIG. 3, the connection system 121 is controlled in step 217 to connect the electrical charging device 119 to the electrical sub-network 106 associated with the healthy phase group 128.

Returning to FIG. 2, in step 218, at least one electrical sub-network isolated in step 204 is used to increase the electrical power collected from the electrical generator 122. To do this, the Supervisor 146 controls the connection device 117 to connect this isolated electrical sub-network to the electrical sub-network associated with a healthy phase group. Thus, the isolated electrical sub-network is connected to the electrical generator 122 through the healthy phase group and can collect electrical power from the electrical generator 122.

In the example shown in FIG. 3, the connection device 117 connects the isolated electrical sub-network 104 to the electrical generator 122 through the electrical sub-network 106, so that electrical power can be collected from it.

Returning to FIG. 2, in an optional step 220, the electrical charging of the equipment in the previously isolated electrical sub-network may then be increased, for example in the same manner as described in step 216.

In the example shown in FIG. 3, the electrical charging of the equipment 112, 108 of the electrical sub-network 104 is for example increased in this step 220.

Precautions may need to be taken when switching equipment from one phase group 126, 128 to another, particularly for the battery 108. Thus, preferably, the method 200 further comprises a step 222 prior to step 218, in which the Supervisor 146 controls the isolation device 110 of the battery 108 to isolate the battery 108 from the rest of the electrical sub-network 104. Thus, the equipment 112 other than the battery 108 may be used to increase the electrical power collected from the electrical generator 122.

Alternatively, the isolation device 110 may be replaced by an accommodation device, allowing the battery 108 to be used to increase the electrical power collected from the electrical generator 122.

For example, the accommodation device comprises a pre-charge resistor that limits the electrical current of the battery 108 until the voltages of the battery 108 and the electrical sub-network 104 equalise. This pre-charge resistor is temporarily connected when the electrical sub-network 104 is connected to the electrical sub-network 106 and then disconnected when the voltages are equalized.

Alternatively, the accommodation device comprises, for example, a direct-direct voltage converter that achieve the voltage adaptation between the battery 108 and the electrical sub-network 104. In this case, the voltage converter is usually present and active at all times.

It is clear that an installation and a method such as those described above allow the electrical generator to be stopped in a short time.

It will be further noted that the invention is not limited to the embodiments described above. It will indeed appear to the person skilled in the art that various modifications can be made to the above-described embodiments, in the light of the teaching just disclosed.

In particular, the electrical generator could comprise more than two phase groups, connected to as many electrical sub-networks.

In the foregoing detailed presentation of the invention, the terms used should not be interpreted as limiting the invention to the embodiments exposed in the present description, but should be interpreted to include all equivalents the anticipation of which is within the reach of the person skilled in the art by applying his general knowledge to the implementation of the teaching just disclosed.

1. An electromechanical installation (100) for an aircraft, comprising:
an electrical network comprising electrical sub-networks electrically disconnected from each other and each comprising at least one electrical equipment;
a turbogenerator comprising:
a gas turbine,
a permanent magnet electrical generator designed to be mechanically driven by the gas turbine and having phase groups respectively connected to the electrical sub-networks, and
for each phase group, an isolation device adapted to disconnect the phase group from its associated electrical sub-network;
a control device adapted to detect a short-circuit in at least one of the phase groups, each phase group in which a short-circuit is detected being referred to as defective and each other phase group being referred to as healthy, and, in response to the detection of the short-circuit, on the one hand, to control the isolation device associated with each defective phase group to disconnect that defective phase group from its associated electrical sub-network and, on the other hand, to control a shutdown of the gas turbine;
wherein the control device is further designed, in response to the detection of the short-circuit, to keep each healthy phase group connected to its electrical sub-network.

2. The installation of claim 1, wherein the control device is designed, after keeping each healthy phase group connected to its electrical sub-network for a period of time, to disconnect all the phase groups from the electrical sub-networks by controlling the isolation device associated with each healthy phase group to disconnect that healthy phase group from its associated electrical sub-network.

3. The installation according to claim 2, wherein the control device is designed to receive a measurement of a rotational speed of the electrical generator, to detect whether a predefined condition relating to the received rotational speed is achieved, this predefined condition being for example that the rotational speed falls below a predefined threshold, and, in response to the detection of the achievement of the predefined condition, to carry out the step of disconnecting all phase groups of the electrical sub-networks.

4. The installation according to claim 1, wherein the control device is designed, in response to the detection of the short-circuit, to increase an electrical power consumption of at least one equipment of an electrical sub-network connected to one of the healthy phase group or groups.

5. The installation according to claim 4, wherein, to increase electrical power consumption of a battery, the control device is designed to increase an electrical voltage applied to the battery by its electrical sub-network so that the battery recharges and/or, to increase the electrical power consumption of an electric motor, the control device is designed to control the electric motor in order to increase a rotational speed of the electric motor and/or to control the electric motor in order to cause the electric motor to generate a reactive current.

6. The installation according to claim 1, further comprising a device for connecting the electrical sub-networks and wherein the control device is designed, in response to the detection of the short-circuit, to control the connection device to connect the electrical sub-network associated with each defective phase group to the electrical sub-network associated with one of the healthy phase group or groups.

7. The installation according to claim 1, further comprising an electrical charging device and a connection system designed to selectively connect the electrical charging device to one or more of the electrical sub-networks and wherein the control device is designed, in response to the detection of the short-circuit, to connect the electrical charging device to an electrical sub-network associated with a healthy phase group.

8. An aircraft comprising an installation according to claim 1.

9. A method for emergency shutdown of a turbogenerator comprising a gas turbine and a permanent magnet electrical generator designed to be mechanically driven by the gas turbine, the method comprising:
a detection of a short-circuit in each of at least one of the phase groups of the electrical generator, the phase groups being respectively connected to electrical sub-networks of an electrical network, the electrical sub-networks being electrically disconnected from each other and each comprising at least one electrical equipment, each phase group in which a short-circuit is detected being referred to as defective and each other phase group being referred to as healthy; and
in response to the detection of the short-circuit:
a disconnection of each defective phase group from its associated electrical sub-network, and
a shutdown of the gas turbine;
characterised in that it further comprises, in response to the detection of the short-circuit, keeping of each healthy phase group connected to its electrical sub-network.

10. A computer program downloadable from a communication network and/or stored on a non-transitory computer-readable medium, comprising instructions for executing the steps of a method for emergency shutdown of a turbogenerator, according to claim 9, when said program is executed on a computer.
